(19) United States
(12) Patent Application Publication
(10) Pub. No.: US 2021/0011445 A1
(43) Pub. Date: Jan. 14, 2021

(54) WIRELESS CONTROLLER FOR DEVICES IN A WATER FILLED HABITAT

(71) Applicants: Scott Dennis Gerber, Ham Lake, MN (US); Karla Lucinda Gerber, Ham Lake, MN (US)

(72) Inventors: Scott Dennis Gerber, Ham Lake, MN (US); Karla Lucinda Gerber, Ham Lake, MN (US)

(21) Appl. No.: 16/946,494

(22) Filed: Jun. 24, 2020

Related U.S. Application Data
(60) Provisional application No. 62/871,914, filed on Jul. 9, 2019.

(51) Int. Cl. G05B 19/042; A01K 63/06; A01K 63/04

(52) U.S. Cl. CPC G05B 19/042; H04W 88/02; A01K 63/042; A01K 63/065

(57) ABSTRACT

A Bluetooth®, or other wireless communications protocol, control of a water filled habitat system. A Bluetooth® phone application will control the duty cycle on a timed basis or programmed to maintain a desired oxygen saturation of the water based on the readings sensed by the oxygen sensor. The Bluetooth® phone application will control the duty cycle on a timed basis or programmed to maintain a desired temperature of the water based on the readings sensed by the temperature sensor. On and off duty cycles will conserve on power supply life and reduce noise and extend the life of the environmental regulating device.

### CROSS-REFERENCE TO RELATED APPLICATION

This application claims the benefit of priority of U.S. provisional application No. 62/871,914, filed Jul. 9, 2019, the contents of which are herein incorporated by reference.

### BACKGROUND OF THE INVENTION

The present invention relates to water filled habitats, and more particularly to controllers for devices providing regulation of one or more habitat variables.

Currently the control of devices used to adjust an environmental variable in a water filled habitat is performed manually or with logic carried on the device or complicated control devices to which the devices are connected.

As can be seen, there is a need for improved systems, apparatus, and methods to control an environmental regulation device for water filled habitats.

### SUMMARY OF THE INVENTION

In one aspect of the present invention, a control system for regulating an environmental condition of a controlled habitat is disclosed. The control system includes one or more environmental control regulating devices in communication with the controlled habitat. The one or more environmental control regulating devices are configured to control one or more environmental parameters of the controlled habitat. A control relay having a wireless communications module is configured to receive a status signal from one or more sensors sensing the one or more environmental parameters and communicate the status signal via the wireless communications module. The control relay is further configured to receive a command signal to power on the one or more environmental control regulating devices.

In some embodiments, the control system also includes a mobile computing device configurable for communication with the wireless communications module. A program logic selectively transmits the command signal to the control relay.

In some embodiments, the program logic also includes receiving the status signal and generating the command signal based on the status signal.

In some embodiments, the program logic further includes receiving a set point for the one or more environmental parameters.

In other embodiments, the program logic further includes transmitting the command signal based on a deviation of status signal from the set point.

In yet other embodiments, the program logic includes receiving a temporal parameter for the command signal. The temporal parameter may be an on time: The temporal parameter may also be an off time.

In certain other embodiments, the one or more sensors comprise a temperature sensor and an oxygen sensor.

In other aspects of the invention, a controlled aquatic habitat is disclosed. The controlled aquatic habitat includes an enclosure configured to contain a volume of water. One or more environmental control regulating devices are in communication with the enclosure. The one or more environmental control regulating devices are configured to control one or more environmental parameters of the volume of water contained in the enclosure. A control relay having a wireless communications module is configured to receive a status signal from one or more sensors sensing the one or more environmental parameters of the enclosure and communicate the status signal via the wireless communications module. The control relay is further configured to receive a command signal to power on the one or more environmental control regulating devices.

In other embodiments, a mobile computing device is in communication with the wireless communications module. A program logic is configured to selectively transmit the command signal to the control relay.

These and other features, aspects and advantages of the present invention will become better understood with reference to the following drawings, description and claims.

### BRIEF DESCRIPTION OF THE DRAWINGS

FIG. 1 is a schematic block diagram of a control system for regulating a controlled environmental habitat.

FIG. 2A is a screen capture of an app for the control system accessed from a mobile phone.

FIG. 2B is a screen capture of an app showing a wireless connection with a wireless control relay.

FIG. 2C is a screen capture of an app showing a plurality of controls for one of a manual operation and a temporal duration.

FIG. 2D is a screen capture of an app showing a user specified set point for an environmental parameter.

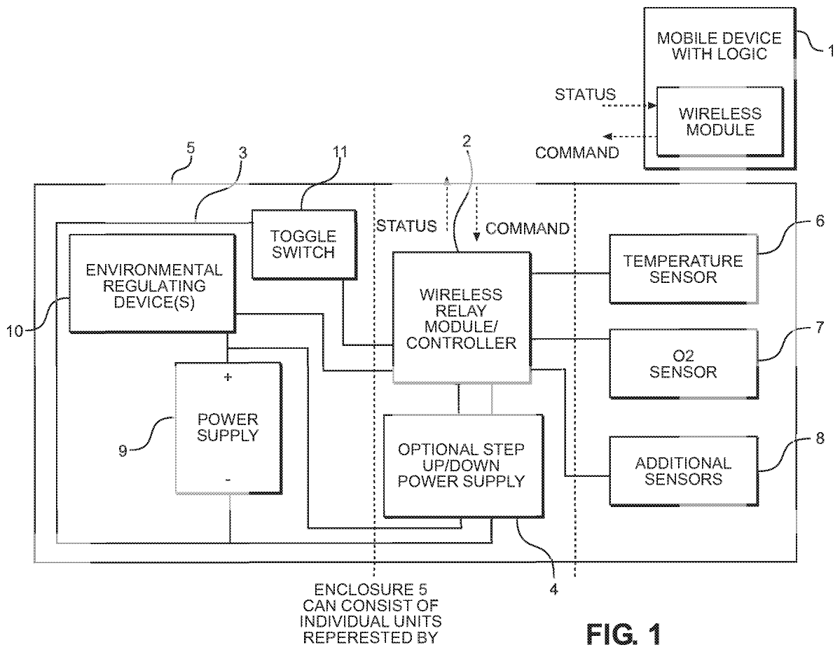

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, embodiments of the present invention provide a system method and apparatus that controls a plurality of environmental regulating devices in a water filled habitat, such as a live well enclosure, utilizing the power and logic available with a cell phone to control the environment of the habitat.

There is currently no control over environmental regulating devices using the logic on a cell phone or tablet. For example; in a water habitat, an environmental regulation device, such as an aerator, does not have to run continuously. A duty cycle for the aerator will depend on a use condition. Relying on an on/off logic to control the environmental regulation device would save power supply life, reduce the amount of noise produced during use, and extend the life of the environmental regulating device.

Utilization of logic on a cell phone, with wireless communication to the environmental regulating device and control of duty cycles does not exist today. Typically, as presently available in the art, this is accomplished with logic integrated with the environmental regulating device or a controller to which it connects. Also, sensors in the habitat can send readings to the phone and the logic on the phone will adjust regulating routines.

Harnessing the logic on the mobile computing device 1, with wireless communication to the environmental regulating device 10, significantly reduces design complexity of the system. It is difficult to control environmental regulating devices such as aerators and pumps manually. The time on or off is easily forgotten and results in a degraded level of habitat environmental characteristics.

Non-limiting embodiments of the present invention discussed herein may include the following elements: a mobile computing device 1, such as a cellular phone or tablet application with an application control logic; a control relay 2 with wireless communication; electrical connections between the control relay 2 and a an optional supply 4; which may be a DC voltage step up/down power supply; an enclosure 5 for containing the components; a water temperature sensor 6; an oxygen sensor 7; other environmental sensors 8; a power supply 9; one or more environmental regulation devices 10; and a switch 11, such as a toggle switch.

As seen in reference to the drawings, the control relay 2 is controlled by the logic provided by an app running on the mobile computing device 1. The control relay 2 communicates status information to a wireless module of the mobile computing device 1 and receives a command signal from the mobile computing device 1. The control relay 2 may selectively operate the one or more environmental regulation devices 10 in response to the command signal. The control relay 2 may also be operatively connected to a switch 11, such as a toggle switch, to power one or more environmental regulation devices 10 in conjunction with the command signal.

In an example embodiment, the present invention relates to environmental control devices 10 utilized in a water filled habitat that are controlled by a mobile computing device 1 having a built-in wireless communication chip, an application with control logic, combined with a wireless control relay 2 has at least one output to power the environmental control device 10. The environmental control devices 10 may include a heater/cooler, an oxygenator, a filter, a pH adjuster, and the like, in communication with the water filled habitat. Each of the one or more environmental control devices 10 control one or more environmental parameters of the water filled habitat. The application on the mobile computing device 1 contains the logic and the wireless signal controls an operational state of the control relay 2.

One or more sensors 6, 7, 8 in the habitat are operatively connected to the control relay 2, which can send sensed environmental parameters of the one or more sensors 6, 7, 8 to the phone 1 as a status input to the logic on the mobile computing device 1, which is configured to adjust the one or more environmental regulation devices 10 to control the environment of the water filled habitat.

The wireless relay module 2 can be configured with a Bluetooth®, a Wi-Fi®, or other wireless communications protocols for communications with the cellular phone 1. The duty cycle may be controlled on a timed basis or may be programmed to maintain a desired environmental parameters of the water filled habitat, such as an oxygen saturation of the water based on one or more readings sensed by the one or more sensors 6, 7, 8, such as by the oxygen sensor 7 and the water temperature sensor 6.

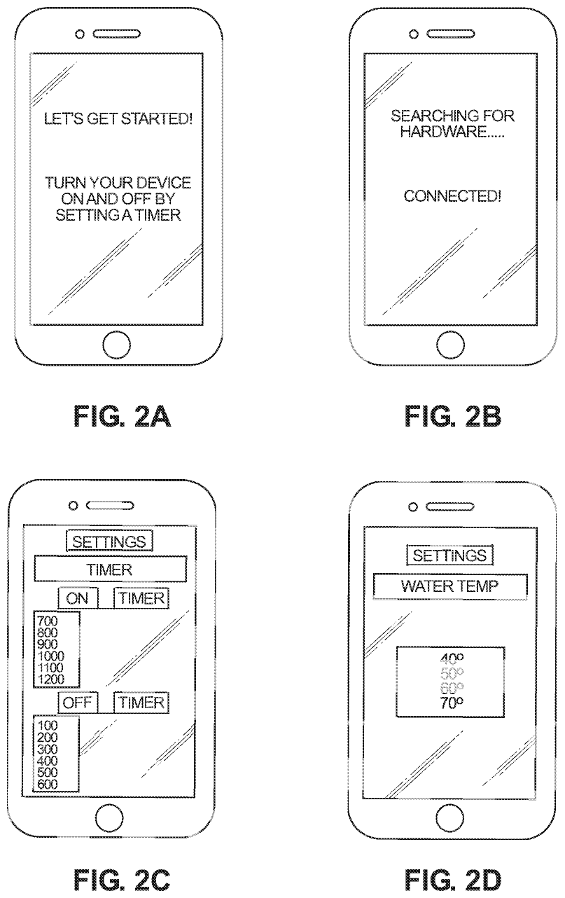

The user may operate the system by downloading the app to their mobile computing device 1. The logic to control the one or more environmental regulating devices 10 is programmed in the application. A welcome screen, such as shown in FIG. 2A may be presented when launching the app. The user may set one or more desired environmental parameters for the one or more environmental regulating devices 10 to maintain within the aquatic habitat. As seen in FIG. 2B, a communications connection is established between the mobile computing device 1 and the wireless relay module 2.

As seen in reference to FIG. 2C, the app may provide for manual control of the one or more environmental regulating devices 10. Selection of an ON control turns the one or more environmental control devices 10 in an operating condition. When the user would like to turn off the one or more environmental control devices 10, an OFF control may then be activated.

The app may also be configured to provide for programming a temporal based duty cycle for the one or more environmental control devices 10. The app permits the user to specify at least one of an operating time and an inactive time. When the temporal duty cycle of the one or more environmental control devices 10 has been set, the device 10 will operate for the specified operating time. When set, the environmental control devices 10 will be turned off for a specified inactive time, after which, the system may be activated again for the specified operating time.

As seen in reference to FIG. 2D, the app may also allow the user to operate the one or more environmental control devices 10 according to a specified environmental parameter for the aquatic environment. In the example shown, a water temperature setting screen is shown. The user may select a desired set point for the water temperature. In this instance, the one or more environmental control devices 10 would be a water heater/cooler. A temperature sensor 6 is operatively coupled to the system to communicate the water temperature of the habitat to the wireless relay module 2. As the water temperature deviates from the desired set point, the app initiates the selected environmental control device 10 until the desired set point is reached.

As previously indicted, the one or more sensors 6, 7, 8 in the habitat can send readings to the mobile computing device 1 and the app logic can adjust the duty cycles for the one or more environmental regulating devices 10 based on the sensed parameters of the one or more sensors 6, 7, 8 and the set point for environmental parameters for the aquatic habitat.

The on and off duty cycles will conserve power supply life and reduce noise of the system. Harnessing the logic on the cell phone 1, with wireless communication with the environmental regulating device 10, significantly reduces design complexity of the system. The software logic updates are easily downloaded to the phone 1 versus a firmware update on a device that would require communication with the device to download the update.

The system of the present invention may include at least one computer with a user interface. The computer may include any computer including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

The computer-based data processing system and method described above is for purposes of example only, and may be implemented in any type of computer system or programming or processing environment, or in a computer program, alone or in conjunction with hardware. The present invention may also be implemented in software stored on a non-transitory computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A control system for regulating an environmental condition of a controlled habitat, comprising:
one or more environmental control regulating devices in communication with the controlled habitat, the one or more environmental control regulating devices configured to control one or more environmental parameters of the controlled habitat; and
a control relay having a wireless communications module, the control relay configured to receive a status signal from one or more sensors sensing the one or more environmental parameters and communicate the status signal via the wireless communications module, the control relay further configured to receive a command signal to power on the one or more environmental control regulating devices.

2. The control system of claim 1, further comprising:
a mobile computing device configurable for communication with the wireless communications module; and
a program logic to selectively transmit the command signal to the control relay.

3. The control system of claim 2, the program logic further comprising:
receiving the status signal; and
generating the command signal based on the status signal.

4. The control system of claim 3, the program logic further comprising:
receiving a set point for the one or more environmental parameters.

5. The control system of claim 4, the program logic further comprising:
transmitting the command signal based on a deviation of status signal from the set point.

6. The control system of claim 3, the program logic further comprising:
receiving a temporal parameter for the command signal.

7. The control system of claim 6, wherein the temporal parameter is an on time.

8. The control system of claim 6, wherein the temporal parameter is an off time.

9. The control system of claim 1, wherein the one or more sensors comprise a temperature sensor and an oxygen sensor.

10. A controlled aquatic habitat, comprising:
an enclosure configured to contain a volume of water;
one or more environmental control regulating devices in communication with the enclosure, the one or more environmental control regulating devices configured to control one or more environmental parameters of the volume of water contained in the enclosure; and
a control relay having a wireless communications module, the control relay configured to receive a status signal from one or more sensors sensing the one or more environmental parameters of the enclosure and communicate the status signal via the wireless communications module, the control relay further configured to receive a command signal to power on the one or more environmental control regulating devices.

11. The controlled aquatic habitat of claim 10, further comprising:
a mobile computing device in communication with the wireless communications module; and
a program logic to selectively transmit the command signal to the control relay.
